(19) United States
(12) Patent Application Publication
(10) Pub. No.: US 2012/0086404 A1
(43) Pub. Date: Apr. 12, 2012

(54) APPARATUS AND METHOD OF CONTROLLING HIGH CURRENT AND POWER STORAGE APPARATUS USING THE SAME

(75) Inventor: Hyung-Hoon Lim, Yongin-city (KR)

(73) Assignee: Samsung SDI Co., Ltd., Yongin-city (KR)

(21) Appl. No.: 13/086,281

(22) Filed: Apr. 13, 2011

(30) Foreign Application Priority Data
Oct. 6, 2010 (KR) 10-2010-0097409

(51) Int. Cl. H02J 7/00

(52) U.S. Cl. 320/128

(57) ABSTRACT

A high current control apparatus is disclosed. The high current control apparatus receives a switching control signal from a battery management system, and controls a main switch of a battery with a second control signal according to the switching control signal. The second control signal is generated with a switching unit which is electromagnetically coupled to a switch control unit which receives the switching control signal from the battery management system.

### CROSS-REFERENCE TO RELATED APPLICATIONS

This application claims priority to and the benefit of Korean Patent Application No. 10-2010-0097409 filed in the Korean Intellectual Property Office on Oct. 6, 2010, the entire contents of which are incorporated herein by reference.

### BACKGROUND

1. Field

The disclosed technology relates to a high current control method, and a power storage device using the same. More particularly, the disclosed technology relates to a high current control device and method that can reduce the influence of noise or surge due to a high voltage and high current on a battery management system, and a power storage device using the same.

2. Description of the Related Technology

Recently, the European Union (EU) has settled on a plan to increase the percentage of renewable energy used to 20% of all energy produced by the year 2020 and to 50% by the year 2050. The US is planning to perform renewable portfolio standards (RPS). Where renewable energy increases from 5% to 30% to 40% in the future, power systems should be prepared for the change.

However, it is not easy to control the percentage of renewable energy produced because the amount of renewable energy generated depends on natural conditions such as sunlight, wind power, and wave power. Thus, a method for overcoming power quality deterioration of the power system that may occur due to fluctuation of the renewable energy and inconsistency between production time and consumption time point has been studied. The power quality is evaluated based on voltage and frequency, and if the supply amount and the demand amount of the renewable energy are not equal to each other, abnormities occur in voltage and frequency so that power quality of the entire power system may be deteriorated.

A power storage system has been given attention as an option for managing fluctuation of the renewable energy. The power storage system stores power if a large amount of power is generated from the renewable energy source and provides power if the consumption amount is greater than that produced by the source.

Power storage techniques includes pumped power storage, compressed air energy storage (CAES), flywheel energy storage, superconducting magnetic energy storage (SMES), and rechargeable batteries. The pumped storage power generation is a method of storing energy by pumping water into an elevated reservoir (e.g., dam) during hours of low consumption. If needed, power is generated by rotating a turbine through water discharge during hours of high consumption. The CAES is a method to store energy by compressing air during periods of low consumption to be used later for generating electricity. The flywheel energy storage is a method of storing energy as momentum in a flywheel. Power is generated by running an electric generator using the flywheel during hours of high consumption. The SMES is a method for storing current in a superconducting coil having negligible resistance. A rechargeable battery that can be repeatedly charged and discharged has been used as an uninterruptible power supply (UPS) that temporarily supplies electricity in case of a power failure, but, recently, it has been given attention as an auxiliary power source for renewable energy systems.

A power storage system can not only store power generated by the renewable energy in a rechargeable battery but can also store and use power of a grid. The rechargeable battery also enables supply of power stored in the rechargeable battery to the grid and to supply the power from the renewable energy source to the grid.

A battery including a plurality of rechargeable batteries coupled in series outputs a high voltage and high current of, for example, about 1 kV and 300 A. On the other hand, a battery management system managing state of charge (SOC) and state of health (SOH) uses a low voltage of about 12V to 24V. The battery management system may be influenced by noise or surge due to the high voltage and high current output from the battery, and accordingly a problem may occur in reliability and stability of the power storage system.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One inventive aspect is a high current control apparatus including a switch control unit configured to control current from a driving power source according to a first switching control signal transmitted from a battery control system to generate a second switching control signal. The apparatus also includes a switching unit configured to control current from the driving power source to a main switch according to the second switching control signal to turn off the main switch, where the main switch is configured to be connected to a battery so that as a result of the main switch being turned off, a voltage and a current output from the battery are blocked.

Another inventive aspect is a high current control method including turning on a first switch in response to receiving a first switching control signal from a battery managing system that manages charging and discharging of a battery, generating a second switching control signal at a first port according to a current flowing from a driving power source through the first switch, turning on a second switch by converting the second switching control signal to an electric signal at a second port insulated from the first port, and turning off a main switch to block a current of the battery by transmitting a third switching control signal to the main switch from the driving power source through the second switch.

Another inventive aspect is a power storage device including at least one battery pack, a battery management system configured to manage charging and discharging of the at least one battery pack, a main switch configured to block a voltage and current output from the at least one battery pack, and a high current control apparatus configured to control the main switch by transmitting a switching control signal transmitted from the battery management system to the main switch. The high current control apparatus electrically isolates a power line of the voltage and current and the battery management system.

### BRIEF DESCRIPTION OF THE DRAWINGS

FIG. 1 is a block diagram of a grid-connected power storage system according to an exemplary embodiment.

FIG. 2 is a block diagram of a power storage device according to some embodiments.

FIG. 3 is a block diagram of a high voltage and high current control apparatus according to some embodiments.

FIG. 4 is a flowchart of a high voltage and high current control method according to some embodiments.

### DETAILED DESCRIPTION OF CERTAIN INVENTIVE EMBODIMENTS

Various features and aspects will be described hereinafter with reference to the accompanying drawings, in which exemplary embodiments are shown. As those skilled in the art would realize, the described embodiments may be modified in various ways, without departing from the spirit or scope of the present invention.

Further, in the exemplary embodiments, like reference numerals generally designate like elements throughout the specification. Some aspects are discussed representatively in a first exemplary embodiment, and different elements are discussed in connection with other embodiments.

The drawings and description are to be regarded as illustrative in nature and not restrictive.

Throughout this specification and the claims that follow, in some situations, if it is described that an element is “coupled” to another element, the element may be coupled to the other element or electrically coupled to the other element through a third element. In addition, unless explicitly described to the contrary, the word “comprise” and variations such as “comprises” or “comprising”, will be understood to imply the inclusion of stated elements but not the exclusion of any other elements.

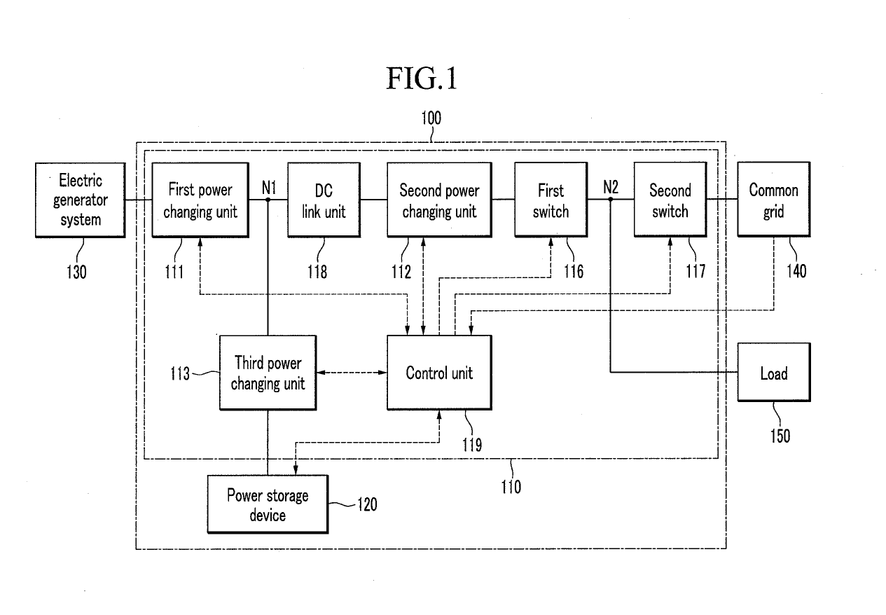

FIG. 1 is a block diagram of a grid-connected power storage system according to an exemplary embodiment.

Referring to FIG. 1, a grid-connected power storage system 100 includes a power management system 110 and a power storage device 120.

The grid-connected power storage system 100 is connected to an electric generator system 130, a common grid 140, and a load 150.

The electric generator system 130 includes a system generating using a renewable energy source, such as sunlight, wind power, wave power, tidal power, or geothermal power. For example, a solar power generating system includes a solar cell module formed of a plurality of solar cells that convert sunlight to electric energy.

The common grid 140 includes a generation plant generating power through, for example, steam power generation, water power generation, or nuclear power generation, a substation that changes the properties of a voltage or a current to transmit generated power through a power transmission line or a power distribution line, or a transmission station.

The load 150 may include various electric devices consuming power. For example, the load 150 may include home electronics or factory equipment.

The power management system 110 connects the electric generator system 130, the common grid 140, and the power storage device 120. The power management system 110 can manage a time difference between production and consumption using the power storage device 120.

The power storage device 120 includes, for example, a rechargeable battery that can be repeatedly charged and discharged. The rechargeable battery includes, for example, at least one of a nickel-cadmium battery, a lead-acid battery, a nickel metal hydride battery, a lithium ion battery, and a lithium polymer battery. The power storage device 120 may be a large capacity storage device formed of a plurality of rechargeable batteries connected in parallel or in series.

A battery management system (BMS) that controls charging and discharging of the rechargeable battery may be included in the power storage device 120 or the power management system 110. The BMS detects a voltage, a current, and a temperature of each cell included in the battery pack and monitors SOC and SOH of each cell to thereby protect cells from overcharge, over-discharge, overcurrent, and overheat, and improves the battery efficiency through cell balancing. If abnormality occurs in a cell the BMS controls a main switch in the power storage device 120 to protect the battery. The main switch may be in an output terminal to which a plurality of battery packs are coupled in series and outputs a high voltage and high current. In some embodiments, the BMS is insulated from the main switch and controls the main switch so that the influence of noise and surge due to the high voltage and high current output from the battery can be minimized.

The power management system 110 includes a first power changing unit 111, a second power changing unit 112, a third power changing unit 113, a first switch 116, a second switch 117, a DC link unit 118, and an control unit 119.

The first power changing unit 111 is connected to the electric generator system 130, and converts first power generated from the electric generator system 130 to second power and transmits the second power to a first node N1. The first power generated from the electric generator system 130 may be DC power or AC power, and the second power in the first node N1 is DC power. That is, the first power changing unit 111 may convert the first power that is DC power to second power that is DC power, or may convert the first power that is AC power to second power that is DC power. The first power changing unit 111 may perform maximum power point tracking (MPPT) control for maximizing power generated from the electric generator system 130. That is, the first power changing unit 111 may be an MPPT converter having a MPPT function.

The DC link unit 118 is connected to the first node N1, and maintains the voltage level of the first node N1 at a substantially constant DC link voltage level. The DC link unit 118 prevents the voltage level of the first node N1 from being unstable due to fluctuation of an output voltage of the electric generator system 130, an instantaneous voltage drop, rapidly changing load conditions, and maximum load occurrence of the load 150 for normal operation of the second and third power changing units 112 and 113. The DC link unit 118 may be a DC link capacitor that is connected in parallel between the first node N1 and the second power changing unit 112. The DC link capacitor may, for example, include an electrolytic capacitor, a polymer capacitor, and a multi-layer ceramic capacitor.

The second power changing unit 112 is connected between the first node N1 and a second node N2, and the common grid 140 and the load 150 are connected to the second node N2. The second power changing unit 112 changes DC power to AC power and transmits the AC power to the second node N2. In addition, the second power changing unit 112 changes the AC power of the second node N2 to DC power and transmits the DC power to the first node N1. That is, the second power changing unit 112 may be a bi-directional converter that converts the DC power of the first node N1 to AC power for the second node N2, and converts the AC power of the second node N2 to DC power for the first node N1. At the second node N2, AC power is supplied to the common grid 140 or AC power is received from the common grid 140.

The third power changing unit 113 is connected between the first node N1 and the power storage device 120. The third power changing unit 113 converts the second DC power to third DC power to be stored in the power storage device 120 and transmits the converted power to the power storage device 120. Further, the third power changing unit 113 converts the third DC power in the power storage device 120 to the second DC power and transmits the converted power to the first node N1. That is, the third power changing unit 113 may be a bi-directional converter that converts DC power of the first node N1 for DC power of the storage device 120 and converts DC power of the power storage device 120 for the first node N1.

The first switch 116 is connected between the second power changing unit 112 and the second node N2, and blocks power flow between the second power changing unit 112 and the second node N2. The second switch 117 is connected between the second node N2 and the common grid 140, and blocks power flow between the second node N2 and the common grid 140. For the first switch 116 and the second switch 117, a field effect transistor (FET) or a bipolar junction transistor (BJT) may be used.

The second switch 117 blocks power to the common grid 140 if, for example, the common grid 140 is in an abnormal state. If the second switch 117 is turned off, the grid-connected power storage system 100 is isolated from the common grid 140 such that it can be independently driven with power from the electric generator system 130 and/or the power storage device 120.

The control unit 119 controls operation of the power management system 110. The control unit 119 receives information (i.e., sensing signals of voltage, current, and temperature) on power generated from the first power changing unit 111, receives power storage information including SOC and SOH from the power storage device 120 (or BMS), and receives grid information including the voltage, current, and temperature of a grid. The control unit 119 controls the driving mode of the power management system 110 based on the power information received from the electric generator system 130, the power storage information of the power storage device 120, and the grid information of the common grid 140. The control unit 119 receives sensing signals of the voltage, the current, and the temperature from the first power changing unit 111, the second power changing unit 112, and the third power changing unit 113, and controls power conversion efficiency of the respective power changing units 111, 112, and 113 according to the driving mode of the power management system 110. The control unit 119 controls the turn-on/off state of the first and second switches 116 and 117 according to the driving mode of the power management system 110.

The driving mode of the power management system 110 may determine power flow direction between at least two of the power storage device 120, the electric generator system 130, the common grid 140, and the load 150. The driving mode of the power management system 110 includes: (1) power supply from the electric generator system 130 to the power storage device 120; (2) power supply from the electric generator system 130 to the common grid 140; (3) power supply from the electric generator system 130 to the load 150; (4) power supply from the power storage device 120 to the common grid 140; (5) power supply from the power storage device 120 to the load 150; (6) power supply from the common grid 140 to the power storage device 120; and (7) power supply from the common grid 140 to the load 150.

In mode (1), power is supplied from the electric generator system 130 to the power storage device 120. In this mode, the control unit 119 transmits an off signal to the first switch 116 to block power flow from the first node N1 to the second node N2. The first power generated from the electric generator system 130 is converted to second DC power in the first power changing unit 111, and a voltage of the second power is stabilized into a DC link voltage level by the DC link unit 118. The second power stabilized in the DC link voltage level is converted to third power of DC in the third power changing unit 113 and is supplied to the power storage device 120 such that the rechargeable battery is charged. In this case, if abnormality occurs in the voltage or the current of the battery, the BMS may block the main switch to protect the battery from overcharge, overcurrent, and overheat of the battery.

In mode (2), power is supplied from the electric generator system 130 to the common grid 140. In this mode, the control unit 119 transmits an off signal to the third power changing unit 113 to block power flow from the first node N1 to the power storage device 120. The control unit 119 transmits an on signal to the first switch 116 and the second switch 117. The first power generated from the electric generator system 130 is converted to the second DC power in the first power changing unit 111, and the voltage of the second power is stabilized into the DC link voltage level by the DC link unit 118. The second power stabilized into the DC link voltage level is converted into DC power in the second power changing unit 112 and is supplied to the common grid 140. In this case, the second power changing unit 112 outputs AC power that corresponds to a power quality standard of the voltage and the current of the common grid 140. The power quality standard includes total harmonic distortion (THD) and a power factor.

In mode (3), power is supplied from the electric generator system 130 to the load 150. In this mode, the control unit 119 transmits an off signal to the third power changing unit 113 and the second switch 117 to block power flow from the first node N1 to the power storage device 120 and the common grid 140. The control unit 119 transmits an on signal to the first switch 116. The first power generated from the electric generator system 130 is converted to the second DC power in the first power changing unit 111, and the voltage of the second power is stabilized into the DC link voltage level by the DC link unit 118. The second power stabilized into the DC link voltage level of the first node N1 is converted to AC power in the second power changing unit 112, and is supplied to the load 150. The load 150 may use the AC power of the common grid 140, and the second power changing unit 112 outputs AC power that corresponds with the power quality standard of the common grid 140, used by the common grid 140.

In mode (4), power is supplied from the power storage device 120 to the common grid 140. In this mode, the control unit 119 transmits an on signal to the first switch 116 and the second switch 117. DC power in an output voltage level of the power storage device 120 is changed to DC power of a DC link voltage level in the third power changing unit 113, and stabilized by the DC link unit 118. In this case, if abnormality occurs in the voltage or the current of the battery, the BMS may block the main switch to protect the battery from overcharge, overcurrent, and overheat of the battery. The power stabilized into the DC link voltage level of the first node N1 is changed into AC power in the second power changing unit 112 and is supplied to the common grid 140.

In mode (5), power is supplied to the load 150 from the power storage device 120. In this mode, the control unit 119 transmits an on signal to the first switch 116 and transmits an off signal to the second switch 117. The DC power in the output voltage level of the power storage device 120 is changed to the DC power of the DC link voltage level in the third power changing unit 113 and stabilized by the DC link unit 118. In this case, if an abnormality occurs in the voltage or the current of the battery, the BMS may block the main switch to protect the battery from overcharge, overcurrent, and overheat of the battery. The power stabilized into the DC link voltage level of the first node N1 is changed to AC power in the second power changing unit 112 and is supplied to the load 150.

In mode (6), power is supplied from the common grid 140 to the power storage device 120. In this mode, the control unit 119 transmits an on signal to the first switch 116 and the second switch 117. The AC power of the common grid 140 is rectified by the second power changing unit 112 and then converted to DC power of the DC link voltage level. The DC power of the DC link voltage level of the first node N1 is converted to DC power of a voltage level for power storage in the third power changing unit 113 and is supplied to the power storage device 120. In this case, if an abnormality occurs in the voltage or the current of the battery, the BMS may block the main switch to protect the battery from overcharge, overcurrent, and overheat of the battery.

In mode (7), that is, if power is supplied from the common grid 140 to the load 150. In this mode, the control unit 119 transmits an off signal to the first switch 116 and transmits an on signal to the second switch 117. The AC power of the common grid 140 is supplied to the load 150.

In the above description, the driving mode of the power management system 110 is classified according to the power supply direction between the power storage system 120, the electric generator system 130, the common grid 140, and the load 150, however in some embodiments, the driving mode of the power management system 110 may be different. For example, power may be supplied from the electric generator system 130 to the power storage device 120 and to the load 150, or may be supplied to the load from the electric generator system 130 and from the power storage device 120. Alternatively, power may be supplied to the common grid 140 and to the load 150 from the electric generator system 130 and the power storage device 120.

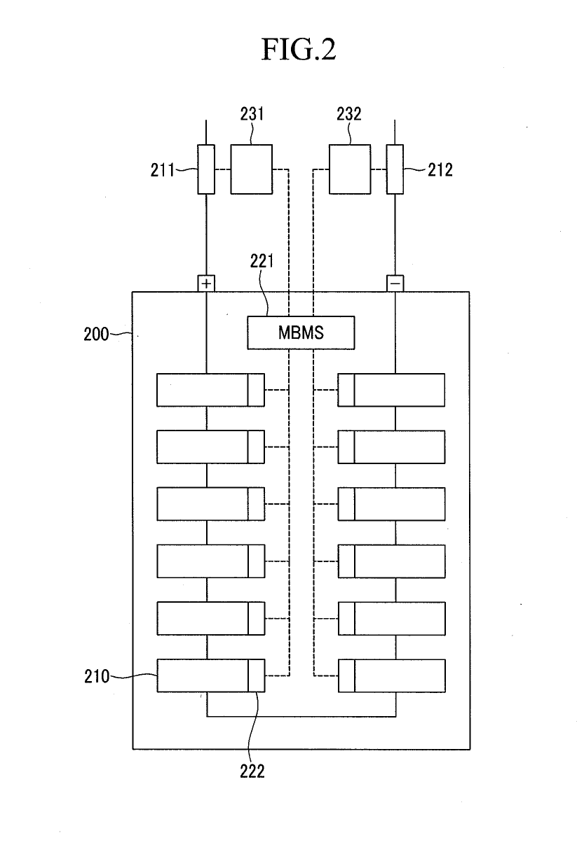

FIG. 2 is a block diagram of the power storage device according to some embodiments.

Referring to FIG. 2, the power storage device 120 includes at least one battery pack 210, a BMS (battery management system) managing charging and discharging of the battery pack 210, main switches 211 and 212 blocking a high voltage and a high current output from the battery pack 210, and high current control apparatuses 231 and 232 blocking the high voltage and the high current by transmitting a switching control signal from the BMS to the main switches 211 and 212. The high voltage path and the high current path are marked by solid lines, and a measurement signal path and a switching control signal path of the BMS are marked by dotted lines.

A plurality of battery packs 210 may be arranged in a battery rack 200. That is, the battery rack 200 may include a plurality of battery packs 210. In this embodiment, the plurality of battery packs 210 are coupled in series and thus may be connected to a positive potential output terminal (+) and a negative potential output terminal (−). The positive potential output terminal (+) and the negative potential output terminal (−) are respectively connected with power lines. The serially coupled plurality of battery packs 210 may output high voltages and high currents to the power lines through the positive potential output terminal (+) and the negative potential output terminal (−). The battery pack 210 includes a plurality of cells coupled in serial and/or parallel.

The BMS includes a plurality of slave BMSs 222 (hereinafter, referred to as SMBS) respectively managing charging and discharging of the battery packs 210 and a master BMS 221 (hereinafter, referred to as MBMS) managing charging and discharging of the entire battery rack 200. Here, the SBMS 222 is provided in each battery pack 210, and the SBMS 222 may be provided to manage charging and discharging of at least one of battery pack 210. In addition, the power storage device 120 uses one battery rack 200 in the present exemplary embodiment, but the power storage device 120 may use a plurality of battery racks and, each of the plurality of battery racks may be provided with a rack BMS and the rack BMS may manage charging and discharging of each battery rack and the MBMS may manage the charging and discharging of the plurality of battery racks.

The SBMS 222 measures a voltage, a current, and a temperature of each cell included in the battery pack 210 and transmits the measured values to the MBMS 221. The MBMS 221 estimates SOC and SOH of each cell or each battery pack 210 from a voltage, a current, and a temperature of each cell, transmitted from each SBMS 222, and controls the charging and discharging of the battery racks 200 based on the SOC and SOH.

Alternatively, the SBMS 222 may estimate SOC and SOH of each cell by measuring a voltage, a current, and a temperature of each cell, and a voltage, a current, and a temperature of each cell and estimated SOC and SOH of each cell may be transmitted to the MBMS 221. The MBMS 221 controls charging and discharging of the battery racks 200 based on SOC and SOH of each cell, transmitted from the SBMS 222.

In addition, the MBMS 221 can determine an abnormality in the voltage, current, or temperature in each battery pack 210 or the entire battery racks 200 based on a voltage, a current, and a temperature of each cell, transmitted from each SBMS 222. If an abnormality is detected in the voltage, current, or temperature of a battery pack 210 or the battery racks 200, the MBMS 221 blocks the main switches 211 and 212 by transmitting a switching control signal to the high current control apparatuses 231 and 232 to protect the battery.

If the MBMS 221 is in an abnormal state, one of the plurality of SBMSs 222 may function as the MBMS 221, and the SMBS 222 functioning as the MBMS 221 may detect an abnormality in the voltage, current, or temperature of the battery rack 200 and transmit the switching control signal to the high current control apparatuses 231 and 232.

The main switches 211 and 212 include a first main switch 211 provided in a power line connected with the positive potential output terminal (+) of the battery rack 200 and a second main switch 212 provided in a power line connected with the negative potential output terminal (−) of the battery rack 200. High voltage and high current switches that can block high voltages and high currents output through the positive potential output terminal (+) and the negative potential output terminal (−) may be used as the main switches 211 and 212. For example, in the battery rack 200 where the plurality of battery packs 210 are coupled in series may output a high voltage and high current of about 1 kV, and about 300 A, and the main switches 211 and 212 may be realized as semiconductors that can block such a high voltage and high current.

The high current control apparatuses 231 and 232 include a first high current control apparatus 231 controlling the first main switch 211 of the positive potential output terminal (+) and a second high current control apparatus 232 controlling the second main switch 212 of the negative potential output terminal (−). Each of the high current control apparatuses 231 and 232 electrically separates the power lines and the MBMS 221, and transmits a switching control signal transmitted from the MBMS 221 or the SBMS 222 to each of the main switches 211 and 212. If a switching control signal is transmitted from each of the high current control apparatuses 231 and 232, each of the main switches 211 and 212 blocks the high voltage and high current. Since the high current control apparatuses 231 and 232 electrically separate the power lines where the high voltage and high current flow and the MBMS 221, the MBMS 221 can be protected from impulse, noise, and surge occurring due to the high voltage and high current.

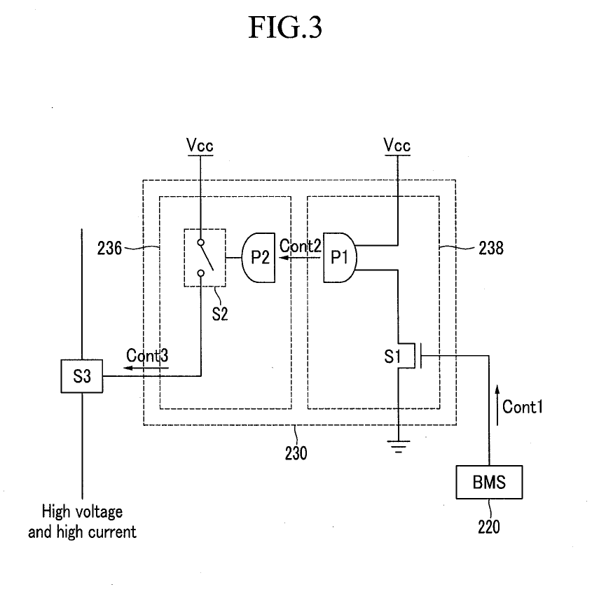

FIG. 3 is a block diagram of the high current control apparatus according to some embodiments.

Referring to FIG. 3, the high current control apparatus 230 includes a switch control unit 238 generating a second switching control signal Cont2 according to a first switching control signal Cont1 transmitted from the BMS 220 and a switching unit 236 that turns on and off a main switch S3 by generating a third switching control signal Cont3 according to the second switching control signal Cont2. The switch control unit 238 and the switching unit 236 are electrically isolated.

The switch control unit 238 includes a first switch S1 that switches a current to flow to the ground from the driving power source Vcc according to the first switching control signal Cont1 and a first port P1 that generates the second switching control signal Cont2 based on the current flowing to the ground from the driving power source Vcc.

The driving power source Vcc may, for example, be equivalent to power that the BMS 220 uses, or may, for example, have a voltage of about 12V to 24V.

An electric field effect transistor may be used as the first switch S1. The electric field effect transistor includes a gate electrode to which the first switching control signal Cont1 is applied, a first terminal connected to first port P1, and a second terminal connected to the ground. If the first switching control signal Cont1 is applied to the gate electrode of the first switch S1 from the BMS 220, the first switch S1 is turned on and a current flows from the first port P1 to the driving power source Vcc.

The first port P1 may be formed with an isolator element or a semiconductor element that emits electromagnetic waves or light waves based on the current flowing from the driving power source Vcc. The second switching control signal Cont2 includes electromagnetic waves or light waves generated in the first port P1 based on the current flowing from the driving power source Vcc.

The switching unit 236 includes a second port P2 converting the second switching control signal Cont2 to an electric signal and a second switch S2 turned on by the electric signal.

The second port P2 is electrically separated from the first port P1, and receives the second switching control signal Cont2 from the first port P1 and converts the signal to an electric signal. The second port P2 transmits the electric signal to the second switch S2.

The second switch S2 connects the driving power source Vcc with the main switch S3. The second switch S2 is turned on by the electric signal transmitted from the second port P2 and controls the current to flow to the main switch S3 from the driving power source Vcc. The third switching control signal Cont3 includes a current flowing to the main switch S3 from the driving power source Vcc through the second switch S2. The second port P2 and the second switch S2 may be formed as an integral switch that controls the current to flow if receiving the electromagnetic waves and light waves.

If the third switching control signal Cont3 is applied through the second switch S2, the main switch S3 is turned off to block the high voltage and high current flowing through the power line. The main switch S3 maintains the turn-off state while the third switching control signal Cont3 is applied, and is turned on if the third switching control signal Cont3 is not applied.

The above-described high current control apparatus 230 electrically separates the switch control unit 238 connected to the BMS 220 from the switching unit 236 connected to the main switch S3, and therefore the BMS 220 can be protected from the impulse, noise, and surge that may flow into the BMS 220 due to the high voltage and high current flowing through the power line. Further, the BMS 220 can continuously maintain the turn-off state of the main switch S3 by transmitting the first switching control signal Cont1 until the abnormality in the current or voltage of the battery is resolved, and can control the main switch S3 to be turned on by stopping transmission of the first switching control signal Cont1 if the abnormality of the battery is resolved.

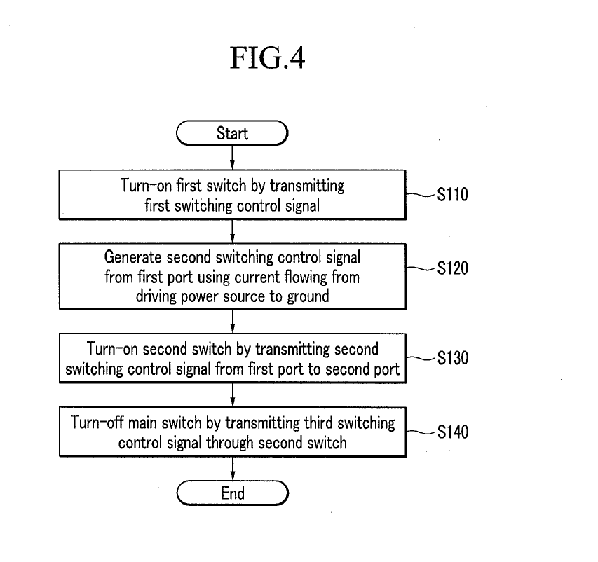

FIG. 4 is a flowchart of a high current control method according to some embodiments.

Referring to FIG. 4, the BMS 220 turns on the first switch S1 by transmitting the first switching control signal Cont1 to the first switch S1 (S110). The BMS 220 may be an MBMS that estimates SOC and SOH of each cell based on a current, a voltage, and a temperature of each cell, or a SBMS. The BMS 220 may detect an abnormality in the voltage and current of the battery by measuring a current, a voltage, or a temperature of each cell, and if the abnormality is detected, the BMS 220 transmits the first switching control signal Cont1 to the first switch S1 to turn on the first switch S1.

If the first switch S1 is turned on, the current flowing to the ground from the driving power source Vcc is transmitted through the first port P1, and the first port P1 generates the second switching control signal Cont2 as, for example, electromagnetic waves and light waves according to the current flowing from the driving power source Vcc to the ground (S120).

The second switching control signal Cont2 is transmitted from the first port P1 to the second port P2 so that the second switch S2 is turned on (S130). The first port P1 transmits the second switching control signal Cont2 to the second port P2 while being electrically isolated from the second port P2 by an isolator. If the second switching control signal Cont2 is transmitted to the second port P2, the second port P2 converts the second switching control signal Cont2 to an electric signal and transmits the electric signal to the second switch S2. The second switch S2 is turned on by the electric signal.

The third switching control signal Cont3 is transmitted to the main switch S3 through the turned-on second switch S2 such that the main switch S3 is turned off (S140). If the second switch S2 is turned on, the third switching control signal Cont3 from the driving power source Vcc is transmitted to the main switch S3. The main switch S3 is turned off if the third switching control signal Cont3 is transmitted to block the high voltage and high current flowing through the power lines.

In order to turn on the main switch S3, the BMS 220 stops transmission of the first switching control signal Cont1 to turn off the first switch S1. If the first switch S1 is turned off, no current flows from the driving power source Vcc to the first port P1 and the first port P1 stops transmission of the second switching control signal Cont2. If the transmission of the second switching control signal Cont2 is stopped, the second switch S2 is turned off. If the second switch S2 is turned off, the current flowing from the driving power source Vcc is blocked so that the main switch S3 is turned on, and the high voltage and high current flows from the battery through the power lines.

While various features and aspects have been described in connection with what is presently considered to be practical exemplary embodiments, it is to be understood that the invention is not limited to the disclosed embodiments, but, on the contrary, is intended to cover various modifications and equivalent arrangements. Therefore, it will be appreciated by those skilled in the art that various modifications may be made and other equivalent embodiments are available.

What is claimed is:

1. A high current control apparatus comprising:
a switch control unit configured to control current from a driving power source according to a first switching control signal transmitted from a battery control system to generate a second switching control signal; and
a switching unit configured to control current from the driving power source to a main switch according to the second switching control signal to turn off the main switch,
wherein the main switch is configured to be connected to a battery so that as a result of the main switch being turned off, a voltage and a current output from the battery are blocked.

2. The high current control apparatus of claim 1, wherein the switch control unit and the switching unit are electrically isolated.

3. The high current control apparatus of claim 2, wherein the switch control unit comprises:
a first switch configured to control the current from the driving power source according to the first switching control signal; and
a first port configured to generate the second switching control signal according to the current from the driving power source.

4. The high current control apparatus of claim 3, wherein the first switch is a transistor, comprising:
a gate electrode to which the first switching control signal is applied,
a first terminal connected with the driving power source, and
a second terminal connected to ground.

5. The high current control apparatus of claim 3, wherein the first port is an isolator element forming electromagnetic waves according to the current flowing from the driving power source, and the second switching control signal is formed by the electromagnetic waves.

6. The high current control apparatus of claim 3, wherein the first port is an isolator element emitting light waves according to the current flowing from the driving power source, and the second switching control signal is formed by the light waves.

7. The high current control apparatus of claim 3, wherein the switching unit comprises:
a second port configured to convert the second switching control signal to an electric signal; and
a second switch turned on by the electric signal to control the current in the main switch.

8. The high current control apparatus of claim 1, wherein the driving power source is a driving power source of the battery control system.

9. The high current control apparatus of claim 1, wherein the battery control system comprises:
a slave battery control system configured to manage charging and discharging of a battery pack including a plurality of cells; and
a master battery control system configured to manage charging and discharging of a battery rack including a plurality of battery packs.

10. The high current control apparatus of claim 9, wherein the first switching control signal is transmitted from the master battery control system if the master battery control system is in a normal state, and is transmitted from the slave battery control system if the master battery control system is in an abnormal state.

11. A high current control method comprising:
turning on a first switch in response to receiving a first switching control signal from a battery managing system that manages charging and discharging of a battery;
generating a second switching control signal at a first port according to a current flowing from a driving power source through the first switch;
turning on a second switch by converting the second switching control signal to an electric signal at a second port insulated from the first port; and
turning off a main switch to block a current of the battery by transmitting a third switching control signal to the main switch from the driving power source through the second switch.

12. The high current control method of claim 11, wherein the second switching control signal is formed by electromagnetic waves.

13. The high current control method of claim 11, wherein the second switching control signal is formed by light waves.

14. The high current control method of claim 11, further comprising detecting an abnormality in a current or a voltage of a cell included in the battery of the battery management system, wherein if the abnormality is detected, the first switching control signal is transmitted to the first switch.

15. The high current control method of claim 11, wherein the main switch maintains the off state as a result of the first switching control signal is transmitted to the first switch in the battery management system.

16. A power storage device comprising:
at least one battery pack;
a battery management system configured to manage charging and discharging of the at least one battery pack;
a main switch configured to block a voltage and current output from the at least one battery pack; and
a high current control apparatus configured to control the main switch by transmitting a switching control signal transmitted from the battery management system to the main switch,
wherein the high current control apparatus electrically isolates a power line of the voltage and current and the battery management system.

17. The power storage device of claim 16, wherein the high current control apparatus comprises:
a switch control unit configured to generate a second switching control signal by controlling a current from a driving power source according to a first switching control signal transmitted from the battery management system; and
a switching unit configured to turn off the main switch by controlling current to the main switch from the driving power source according to the second switching control signal, and
the switch control unit and the switching unit are electrically separated.

18. The power storage device of claim 17, wherein the switch control unit comprises:
a first switch configured to control the current from the driving power source according to the first switching control signal; and
a first port configured to generate the second switching control signal according to the current flowing from the driving power source.

19. The power storage device of claim 18, wherein the switching unit comprises:
a second port configured to convert the second switching control signal to an electric signal; and
a second switch turned on by the electric signal to control the current to the main switch from the driving power source.

20. The power storage device of claim 17, wherein the driving power source is a driving power source of the battery control system.

21. The power storage device of claim 16, wherein the main switch comprises:
a first main switch provided at a positive power line connected with a positive potential output terminal of the at least one battery pack; and
a second main switch provided at a negative power line connected with a negative potential output terminal of the at least one battery pack.

22. The power storage device of claim 21, wherein the high current control apparatus comprises:
a first high current control apparatus controlling the first main switch; and
a second high current control apparatus controlling the second main switch.
